(19) United States
(12) Patent Application Publication
(10) Pub. No.: US 2016/0252662 A1
(43) Pub. Date: Sep. 1, 2016

(54) REFLECTOR AND MICROSCOPE

(71) Applicant: OLYMPUS CORPORATION, Tokyo (JP)

(72) Inventors: Kentaro YAMAZAKI, Tokyo (JP); Kei KIKUCHI, Tokyo (JP)

(73) Assignee: OLYMPUS CORPORATION, Tokyo (JP)

(21) Appl. No.: 15/040,888

(22) Filed: Feb. 10, 2016

(30) Foreign Application Priority Data
Feb. 27, 2015 (JP) 2015-039261

(51) Int. Cl. G02B 5/08; G02B 21/00

(52) U.S. Cl. CPC G02B 5/0858; G02B 21/0076; G02B 21/0064; G02B 21/0032

(57) ABSTRACT

A reflector includes: an Au film formed over a board; and a dielectric multilayer formed over the Au film, the dielectric multilayer having a reflectance higher than that of the Au film in a visible wavelength region.

### CROSS REFERENCE TO RELATED APPLICATIONS

This application is based upon and claims the benefit of priority from prior Japanese Patent Application No. 2015-039261, filed Feb. 27, 2015, the entire contents of which. are incorporated herein by this reference.

### BACKGROUND OF THE INVENTION

1. Field of the Invention

The present invention relates to a reflector and a microscope including the reflector, in particular, a reflector having a high reflectance in a wide wavelength band and a microscope including the reflector.

2. Description of the Related Art

In the field of microscopes, an aluminum mirror is conventionally used for a reflector. The aluminum mirror has a high reflectance in a visible wavelength region, and has a lower reflectance in an infrared wavelength region than in the visible wavelength region. Accordingly, in recent years, in which multi-photon excitation microscopes and the like have spread, a reflector in which an Ag (silver) film having a high reflectance in the infrared wavelength region in addition to the visible wavelength region is formed has also been used. The reflector in which the Ag film is formed is described, for example, in Japanese Laid-Open Patent Publication No. 8-234004, Japanese Laid-Open Patent Publication No. 11-149005, and the like.

It is known that the reflector in which the Ag film is formed can realize a high reflectance in a wide wavelength band including the infrared wavelength region, but has a low durability against temperature and humidity. Therefore, a protective film is usually formed on the Ag film in order to maintain the performance of the reflector.

### SUMMARY OF THE INVENTION

In a first aspect of the present invention, a reflector is provided that includes: an Au film formed over a board; and a dielectric multilayer formed over the Au film, the dielectric multilayer having a reflectance higher than that of the Au film in a visible wavelength region.

In another aspect of the present invention, a microscope including the reflector in the first aspect is provided.

### BRIEF DESCRIPTION OF THE DRAWINGS

The present invention will be more apparent from the following detailed description when the accompanying drawings are referenced.

FIG. 1 is a diagram explaining a reflector according to an embodiment of the present invention.

FIG. 2 illustrates a relationship between the thickness of an Au film and a spectral reflectance.

FIG. 3 illustrates a configuration of a microscope including a reflector according to an embodiment of the present invention.

FIG. 4 illustrates refractive indices and absorption coefficients of a high-refractive-index layer and a low-refractive-index layer included in a reflector according to Example 1 of the present invention.

FIG. 5 illustrates spectral reflectances of a reflector, an Au film, and a dielectric multilayer according to Example 1 of the present invention.

FIG. 6 illustrates refractive indices and absorption coefficients of a high-refractive-index layer and a low-refractive-index layer included in a reflector according to Example 2 of the present invention.

FIG. 7 illustrates spectral reflectances of a reflector, an Au film, and a dielectric multilayer according to Example 2 of the present invention.

FIG. 8 illustrates spectral reflectances of a reflector, an Au film, and a dielectric multilayer according to Example 3 of the present invention.

FIG. 9 illustrates spectral reflectances of a reflector, an Au film, and a dielectric multilayer according to Example 4 of the present invention.

FIG. 10 illustrates refractive indices and absorption coefficients of a high-refractive-index layer and a low-refractive-index layer included in a reflector according to Example 5 of the present invention.

FIG. 11 illustrates spectral reflectances of a reflector, an Au film, and a dielectric multilayer according to Example 5 of the present invention.

### DESCRIPTION OF THE EMBODIMENTS

In order to sufficiently exhibit the performance of a reflector in which an Ag film is formed, it is preferable that a protective film have a high transmittance over a wide wavelength band. However, it is difficult to design a protective film having a high transmittance over a wide band. In particular, it is very difficult to form a protective film having a high durability against temperature and humidity under such a design limitation in a transmittance characteristic,

Embodiments of the present invention are described below in detail.

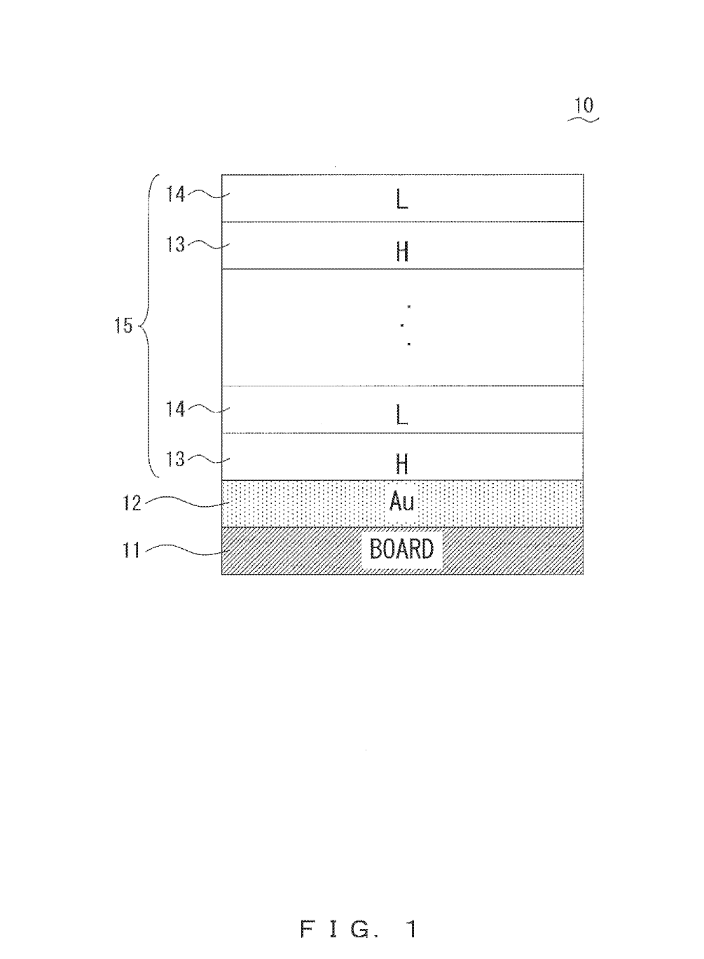

FIG. 1 is a diagram explaining a reflector 10 according to an embodiment of the present invention. The reflector 10 is a reflector that is reflecting mirror having a high reflectance in a wide wavelength band from a visible wavelength region to an infrared wavelength region. The reflector 10 includes a board 11, an Au (gold) film 12 formed over the board 11, and a dielectric multilayer 15 formed over the Au film 12.

In this specification, the visible wavelength region is a wavelength region from about 400 nm to about 700 nm. The infrared wavelength region is a wavelength region from about 700 nm to about 2500 nm. An ultraviolet wavelength region is a wavelength region less than 400 nm.

A material (a base material) of the board 11 is not particularly limited, but it is, for example, optical glass S-BSL7 from Ohara Inc.

The Au film 12 is a thin film composed of Au (gold) , and is formed over the board 11. Au has a higher durability against temperature and humidity than Ag (silver) used in a conventional wide-wavelength-band mirror, and also has a high reflectance in the infrared wavelength region, similarly to Ag. The Au film 12 may be formed so as to interpose a layer between the Au film 12 and the board 11. Namely, the phrase “over the board 11” includes “on the board 11” and “above the board 11”, and the Au film 12 does not always need to be formed on the board 11 so as to be in contact with the board 11, as illustrated in FIG. 1.

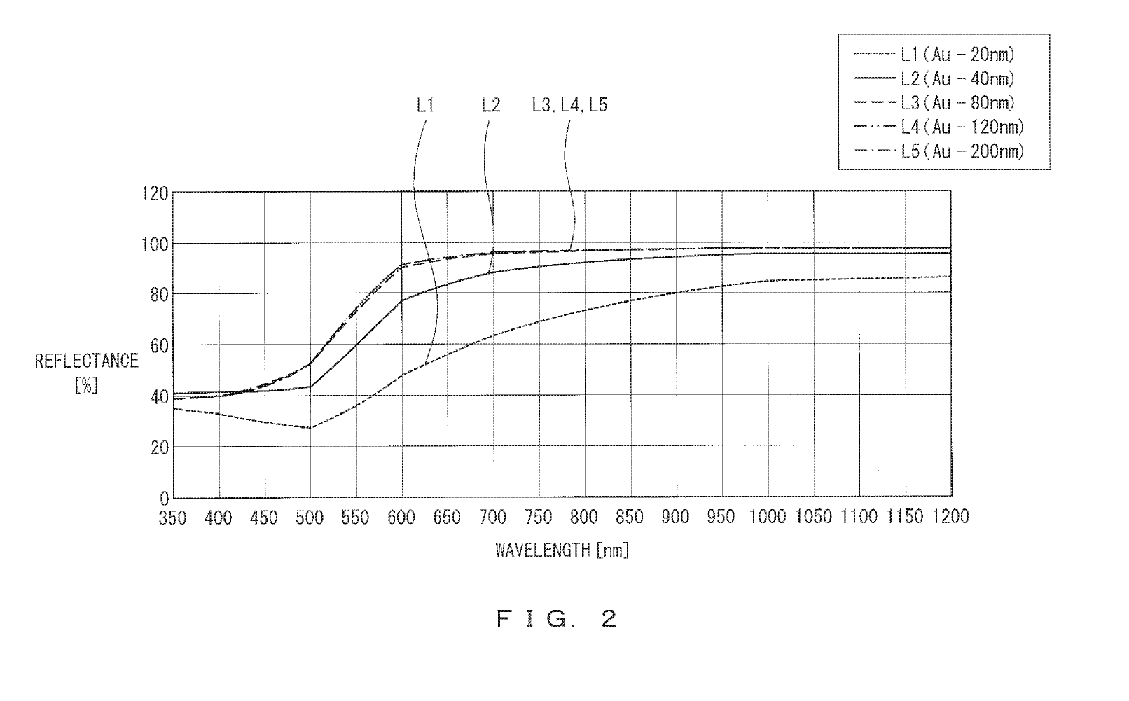

FIG. 2 illustrates a relationship between the thickness of the Au film 12 and a spectral reflectance, which is a reflectance at each wavelength. In FIG. 2, spectral reflectances of Au films having thicknesses of 20 nm, 40 nm, 80 nm, 120 nm, and 200 nm are respectively represented using lines L1, L2, L3, L4, and L5. These reflectances are reflectances at an incident angle of 45°. Hereinafter, it is assumed that the reflectance is a reflectance at an incident angle of 45°, unless otherwise noted.

As the thickness of the Au film 12 increases up to about 80 nm, the reflectance is further improved, as illustrated in FIG. 2; however, when the thickness of the Au film 12 is greater than or equal to 80 nm, the reflectance hardly changes. Therefore, in order to achieve the reflector 10 having a high reflectance, it is preferable that the Au film 12 have a thickness of 80 nm or more. Considering that Au is an expensive material, it is preferable that the Au film 12 be formed so as to have a thickness that is greater than or equal to 80 nm, and is close to 80 nm.

The dielectric multilayer 15 is an optical thin-film laminate formed by alternately laminating a high-refractive-index layer 13 and a low-refractive-index layer 14 having a refractive index lower than the refractive index of the high-refractive-index layer 13. The dielectric multilayer 15 is formed over the Au film 12. The high-refractive-index layer 13 and the low-refractive-index layer 14 are composed of materials having different refractive indices. The high-refractive-index layer 13 is composed, for example, of TiO₂ or Ta₂O₅. The low-refractive-index layer 14 is composed, for example, of SiO₂ or MgF₂. It is preferable that the thicknesses of the high-refractive-index layer 13 and the low-refractive-index layer 14 that are alternately laminated do not greatly differ from each other from the viewpoint of ease of film formation. The dielectric multilayer 15 may be formed so as to interpose a layer between the dielectric multilayer 15 and the Au film 12. Namely, the phrase “over the Au film 12” includes “on the Au film 12” and “above the Au film 12”, and the dielectric multilayer 15 does not always need to be formed on the Au film 12 so as to be in contact with the Au film 12, as illustrated in FIG. 1.

Au and the Au film 12 have a high reflectance in the infrared wavelength region, as illustrated in FIG, 2, but have a relatively low reflectance in the visible wavelength region. Specifically, an Au film 12 having a thickness of 80 nm or more has a particularly high reflectance that exceeds 95% in a wavelength region of 700 nm or more under the condition of an incident angle of 45°. On the other hand, the reflectance gradually decreases in a wavelength region of about 650 nm, and the reflectance decreases up to about 90% at a wavelength of about 600 nm, and decreases up to about 40% at a wavelength of about 400 nm. The dielectric multilayer 15 compensates for a reflectance in the visible wavelength region in which the Au film 12 has a relatively low reflectance. The dielectric multilayer 15 is a dichroic mirror that has been designed so as to have a reflectance higher than the reflectance of the Au film 12 in the visible wavelength region. The dielectric multilayer 15 does not need to have a reflectance higher than that of the Au film 12 in the entirety of the visible wavelength region, and may have a reflectance higher than that of the Au film 12 in at least a portion of the visible wavelength region.

It is preferable that the dielectric multilayer 15 be a dichroic mirror that has been designed so as to have a reflectance higher than that of the Au film 12, for example, at least in a wavelength region of 400 nm to 600 nm. This is because the reflectance of the Au film 12 is low, in particular in the wavelength region of 400 nm to 600 nm in the visible wavelength region.

It is further preferable that the dielectric multilayer 15 be a dichroic mirror that has been designed so as to have a reflectance higher than that of the Au film 12 in a wavelength region of 350 nm to 650 nm including the ultraviolet wavelength region. The dielectric multilayer 15 may have a rising edge wavelength of short-wavelength reflection and long-wavelength transmission in a band of 600 nm to 700 nm, such as about 650 nm, and may have a rising edge wavelength of long-wavelength reflection and short-wavelength transmission in a band of 400 nm or less.

In the reflector 10 with the configuration above, principally the Au film 12 can realize a high reflectance in the infrared wavelength region and principally the dielectric multilayer 15 can realize a high reflectance in the visible wavelength region (and the ultraviolet wavelength region) Therefore, a high reflectance can be realized in a wide wavelength band from the visible wavelength region or the ultraviolet wavelength region to the infrared wavelength region. The dielectric multilayer 15 generally has a high durability against temperature and humidity. The Au film 12 also has a high durability against temperature and humidity, compared with an Ag film. Accordingly, the reflector 10 can achieve a higher durability against temperature and humidity than a conventional wide-wavelength-band mirror in which a protective film is formed on the Ag film. Thus, the reflector 10 enables both a high reflectance and a high durability against temperature and humidity in a wide wavelength band from the visible wavelength region or the ultraviolet wavelength region to the infrared wavelength region.

The reflector 10 can be widely used in the field of optical apparatuses including microscopes, and it is particularly preferable that the reflector 10 be used in optical apparatuses in which both infrared light and visible light (or the ultraviolet wavelength region) are used, such as infrared microscopes, Raman microscopes, or multiphoton excitation microscopes (for example, two-photon excitation microscopes). An example of a microscope including the reflector 10 is described below.

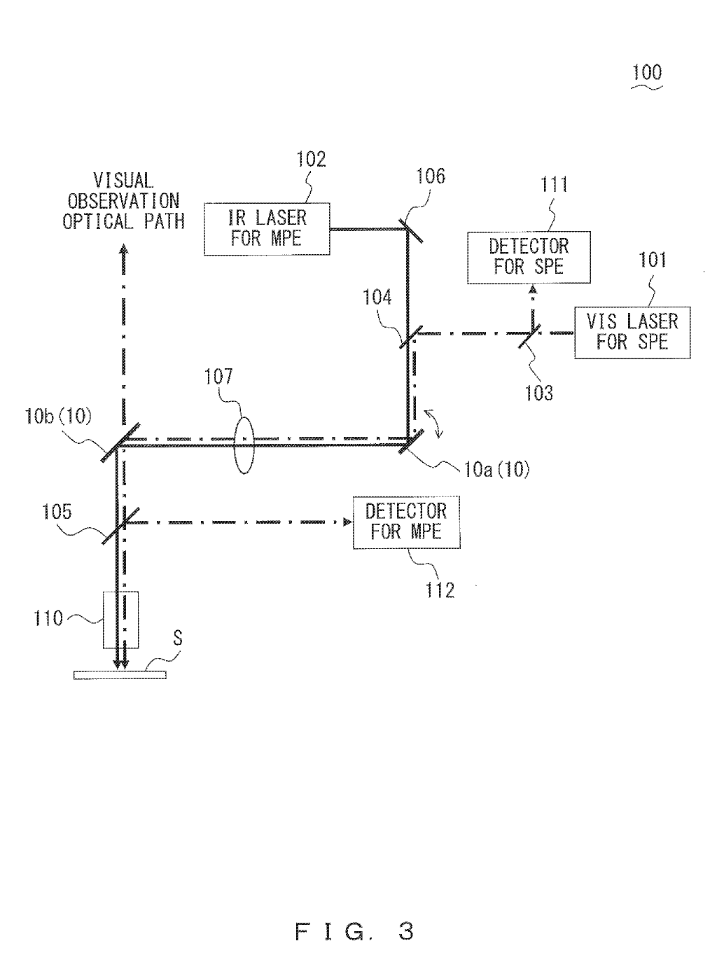

FIG. 3 illustrates a configuration of a microscope 100 including the reflector 10 according to an embodiment of the present invention. In FIG. 3, infrared light is drawn with a solid line, and visible light is drawn with an alternating long and short dashed line. The microscope 100 is a laser scanning fluorescence microscope that enables one-photon excitation (SPE) imaging in which a sample S is irradiated with visible light so as to be excited, and two-photon excitation (MPE) imaging in which the sample S is irradiated with infrared light so as to be excited. The microscope 100 is both a one-photon excitation microscope and a two-photon excitation microscope.

As illustrated in FIG. 3, the microscope 100 includes an objective 110, a laser 101 and a detector 111 for one-photon excitation, a laser 102 and a detector 112 for two-photon excitation, a scanning optical system 107, and various mirrors (dichroic mirrors 103, 104, and 105, a gold mirror 106, and reflectors 10a and 10b).

The gold mirror 106 is a mirror that is arranged in a position where only infrared light from the laser 102 enters. The gold mirror 106 has a high reflectance in the infrared wavelength region, and therefore the gold mirror 106 can efficiently reflect the infrared light from the laser 102.

The reflectors 10a and 10b are reflecting mirrors similar to the reflector 10 described above, and are reflecting mirrors in which the dielectric multilayer 15 having a reflectance higher than that of the Au film 12 in the visible wavelength region is formed over the Au film 12. The reflectors 10a and 10b are arranged in positions where visible light from the laser 101, fluorescence (visible light) emitted from a sample S excited by the visible light from the laser 101, and infrared light from the laser 102 enter. The reflectors 10a and 10b have a high reflectance in a wide wavelength band from the visible wavelength region to the infrared wavelength region, and therefore the reflectors 10a and 10b can efficiently reflect the visible light (including the fluorescence) and the infrared light.

The reflector 10a is a mirror that configures a scanner such as a galvano-scanner. The reflector 10b is a mirror that is removably arranged in an optical path. In a case in which a sample S illuminated, for example, by a transmission illumination means not illustrated is visually observed, the reflector 10b is removed from the light path.

The microscope 100 having the configuration above enables light to be efficiently reflected by using the reflectors 10a and 10b in both one-photon excitation imaging and two-photon excitation imaging. As a result, a bright fluorescent image can be obtained. In particular, in two-photon excitation imaging, a luminous efficiency of fluorescence is proportional to the square of an average power of excitation light, and consequently, deterioration in the luminous efficiency of fluorescence is also proportional to the square of an amount of deterioration in reflectance. Accordingly, the reflectors 10a and 10b having a high reflectance are extremely useful. Further, the reflectors 10a and 10b have a high durability compared with a conventional wide-wavelength-band mirror in which an Ag film is formed, and this allows the frequency of exchanging reflectors to be reduced.

Specific examples of the reflector 10 described above are described below.

### EXAMPLE 1

A reflector according to this example is a reflecting mirror, and includes a board 11, an Au film 12 formed over the board 11, and a dielectric multilayer 15 that is a dichroic mirror formed over the Au film 12, as illustrated in FIG. 1. The board 11 is optical glass S-BSL7 from Ohara Inc The thickness of the Au film 12 is 80 nm.

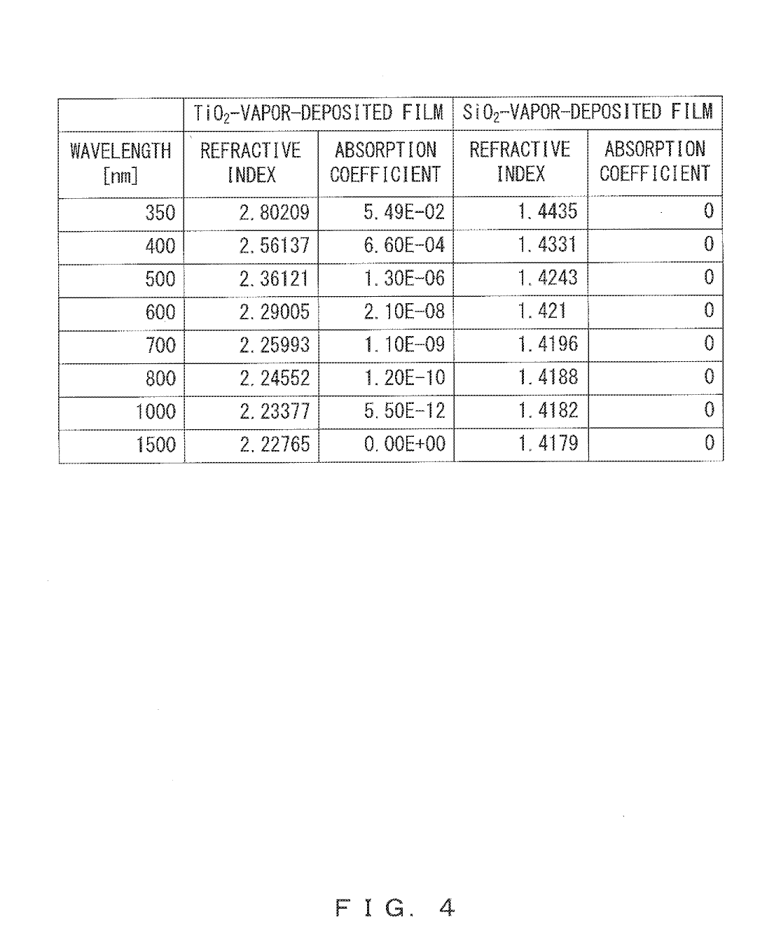

The dielectric multilayer 15 is an optical thin-film laminate formed by alternately laminating a high-refractive-index layer 13 that is a vapor-deposited film composed of TiO₂, and a low-refractive-index layer 14 that is a vapor-deposited film composed of SiO₂. Refractive indices and absorption coefficients of the vapor-deposited film composed of TiO₂ and the vapor-deposited film composed of SiO₂ are illustrated in FIG. 4. The absorption coefficient of the vapor-deposited film composed of SiO₂ is less than or equal to 10⁻⁶, and therefore the absorption coefficient of the vapor-deposited film composed of SiO₂ is described as 0 in FIG. 4.

When a design wavelength λ0 is 600 nm, a film structure of the dielectric multilayer 15 in a direction from the side of the board 11 to the air side is as described below. Here, H represents the high-refractive-index layer 13, L represents the low-refractive-index layer 14, and a numerical value before H or L represents the thickness of each of the layers that is calculated under the assumption that design wavelength λ0×1/4−1. The 0 before the decimal point is omitted.

Dielectric Multilayer 15 .3933H .72682L .61295H .50916L .57695H .65639L .58225H .683 94L .53476H .70861L .62952H .64346L .5804H .67874L .5537H .71281 .56974H .58891L .59547H .69449L .62499H .6801L .61114H .718381 .65609H .73035L .60771H .63278L .63942H .75466L .63918H .70997L .62651H .719221 .71487H .83822L .74725H .800 55L .66412H .90132L .79718H .82424L .76094H .828991 .7995H .856871 .82086H .86419L .83028H .87225L .83317H .87523L .82 739H .85338L .79906H .84531L .78325H .79256L .6926H 1.03062L .91033H 1.11103L .94956H 1.03235L .89546H 1.11273L 1.0212411 1.09312L .89429H 1.08402L .94595H 1.14538L .8992H 1.10017L .95718H 1.11426L .91803H 1.05893L .91007H 1.12409L 1.03133H 1.89058L

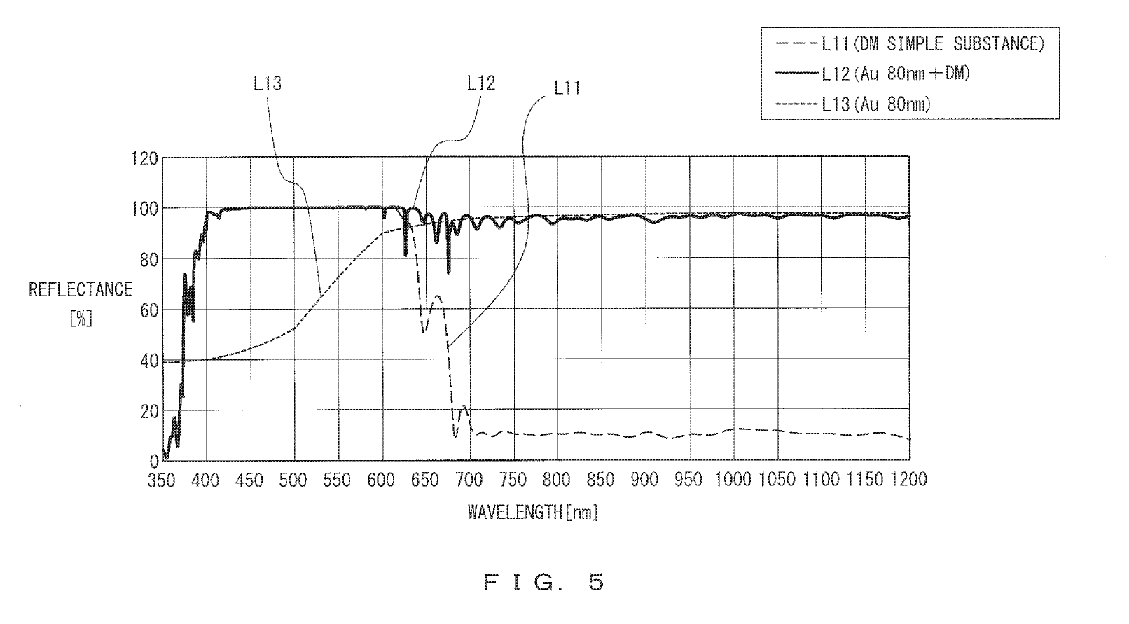

FIG. 5 illustrates spectral reflectances of the reflector, the Au film 12, and the dielectric multilayer 15 according to this example. All of the reflectances are reflectances at an incident angle of 45°. As is clear when comparing a line L13 representing the spectral reflectance of the dielectric multilayer 15 (a DM simple substance) and a line L13 representing the spectral reflectance of the Au film 12, the dielectric multilayer 15 has a reflectance higher than that of the Au film 12 at least in a wavelength region between 400 nm and 600 nm.

By using the reflector according to this example, a high reflectance can be achieved in a wide wavelength band from the visible wavelength region to the infrared wavelength region, as represented by a line L12 in FIG. 5, and a high durability against temperature and humidity can also be achieved.

### EXAMPLE 2

A reflector according to this example is a reflecting mirror, and is different from the reflector according to Example 1 in that a film structure of a dielectric multilayer is different from the film structure of the dielectric multilayer 15. In the other respects, the reflector according to this example is similar to the reflector according to Example 1.

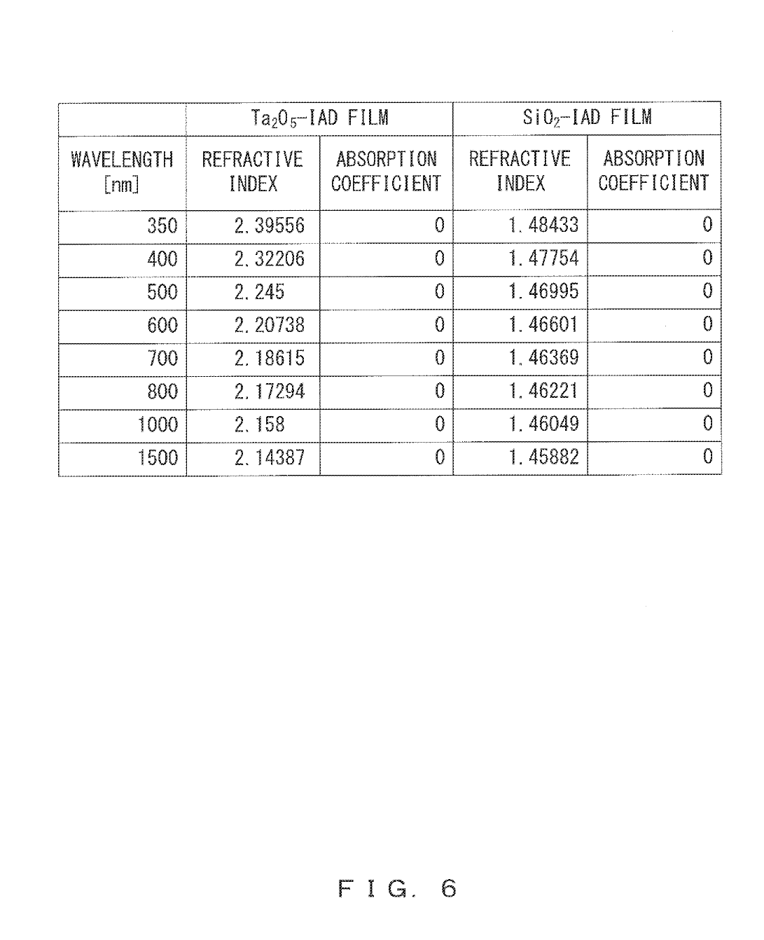

A dielectric multilayer according to this example is an optical thin-film laminate formed by alternately laminating a high-refractive-index layer that is an IAD (Ion assisted deposition) film composed of Ta₂O₅, and a low-refractive-index layer that is an IAD film composed of SiO₂. Refractive indices and absorption coefficients of the IAD film composed of Ta₂O₅ and the IAD film composed of SiO₂ are illustrated in FIG. 6. The absorption coefficient of the IAD film composed of SiO₂ is less than or equal to 10⁻⁶, and therefore the absorption coefficient of the IAD film composed of SiO₂ is described as 0 in FIG. 6.

When a design wavelength λ0 is 600 nm, a film structure of the dielectric multilayer according to this example in a direction from the side of the board 11 to the air side is as described below. Here, H represents the high-refractive-index layer, L represents the low-refractive-index layer, and a numerical value before H or L represents the thickness of each of the layers that is calculated under the assumption that design wavelength λ0×1/4=1. The 0 before the decimal point is omitted. A numerical value after ( ) represents the number of repetitions of a structure described in ( ).

### Dielectric Multilayer (.5775H .6825L)8 (.6825H .7665L)8 (.861H .8925L)8 (1.05H 1.05L)8 1.05H 1.785L

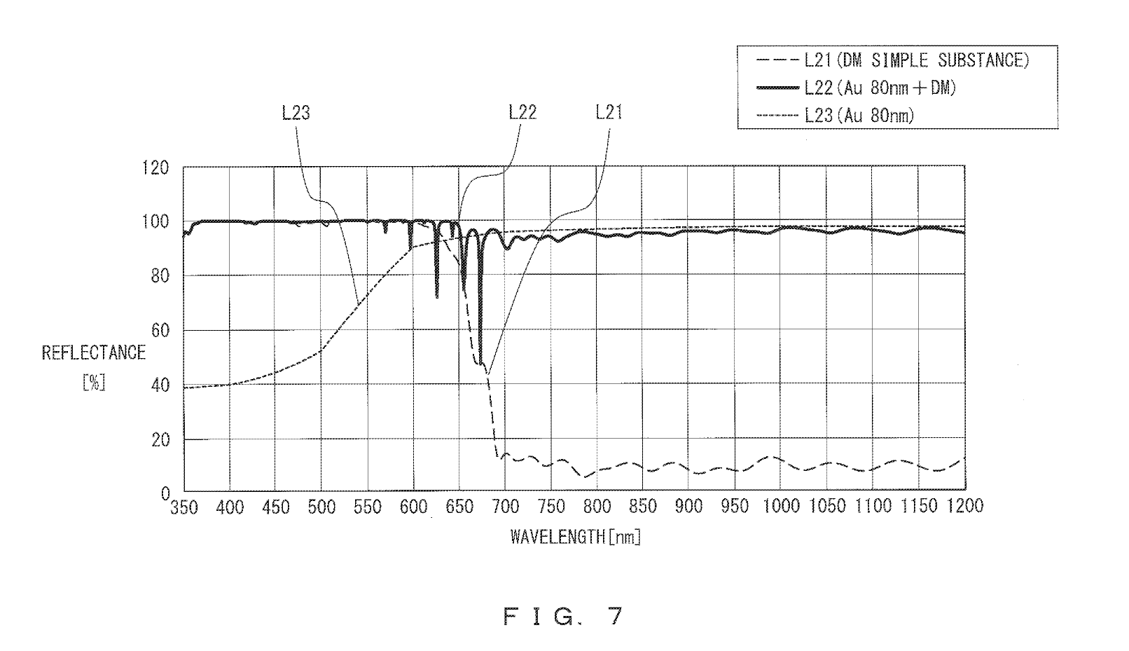

FIG. 7 illustrates spectral reflectances of the reflector, an Au film 12, and the dielectric multilayer according to this example. All of the reflectances are reflectances at an incident angle of 45°. As is clear when comparing a line L21 representing the spectral reflectance of the dielectric multilayer (a DM simple substance) and a line L23 representing the spectral reflectance of the Au film 12, the dielectric multilayer has a reflectance higher than that of the Au film 12 at least in a wavelength region between 400 nm and 600 nm. Further, the dielectric multilayer has a reflectance higher than that of the Au film 12 in a wavelength region between 350 nm and 600 nm.

By using the reflector according to this example, a high reflectance can be achieved in a wide wavelength band from the visible wavelength region to the infrared wavelength region, as represented by a line L22 in FIG. 7, and a high durability against temperature and humidity can also be achieved, similarly to Example 1. Further, a high reflectance can be achieved in the ultraviolet wavelength region. Accordingly, the reflector according to this wavelength can be employed, for example, in a multi-photon excitation microscope that performs three-photon excitation.

### EXAMPLE 3

A reflector according to this example is a reflecting mirror, and is different from the reflector according to Example 1 in that a film structure of a dielectric multilayer is different from the film structure of the dielectric multilayer 15. In the other respects, the reflector according to this example is similar to the reflector according to Example 1.

A dielectric multilayer according to this example is an optical thin-film laminate formed by alternately laminating a high-refractive-index layer that is an IAD (Ion assisted deposition) film composed of Ta₂O₅, and a low-refractive-index layer that is an IAD film composed of SiO₂, similarly to the dielectric multilayer according to Example 2. Refractive indices and absorption coefficients of the IAD film composed of Ta₂O₅ and the IAD film composed of SiO₂ are illustrated in FIG. 6.

When a design wavelength AO is 600 nm, a film structure of the dielectric multilayer according to this example in a direction from the side of the board 11 to the air side is as described below. Here, H represents the high-refractive-index layer, L represents the low-refractive-index layer, and a numerical value before H or L represents the thickness of each of the layers that is calculated under the assumption that design wavelength λ0×1/4=1. The 0 before the decimal point is omitted. A numerical value after ( ) represents the number of repetitions of a structure described in ( ).

### Dielectric Multilayer (.68H .76L)8 (.86H .89L)8 (1.05H 1.1L)8 1.05H 1.785L

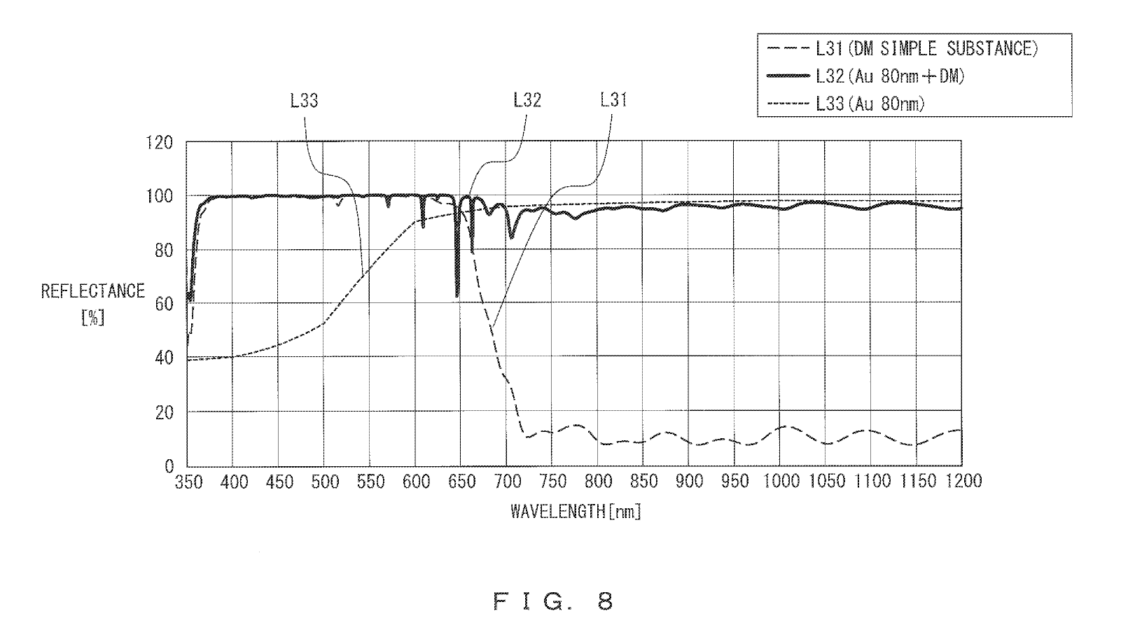

FIG. 8 illustrates spectral reflectances of the reflector, an Au film 12, and the dielectric multilayer according to this example. All of the reflectances are reflectances at an incident angle of 45°. As is clear when comparing a line L31 representing the spectral reflectance of the dielectric multilayer (a DM simple substance) and a line L33 representing the spectral reflectance of the Au film 12, the dielectric multilayer has a reflectance higher than that of the Au film 12 at least in a wavelength region between 400 nm and 600 nm. Further, the dielectric multilayer has a reflectance higher than that of the Au film 12 in a wavelength region between 350 nm and 600 nm.

By using the reflector according to this example, a high reflectance can be achieved in a wide wavelength band from the visible wavelength region to the infrared wavelength region, as represented by a line L32 in FIG. 8, and a high durability against temperature and humidity can also be achieved, similarly to Example 1. Further, a high reflectance can be achieved in the ultraviolet wavelength region. Accordingly, the reflector according to this example can be employed, for example, in a multi-photon excitation microscope that performs three-photon excitation.

### EXAMPLE 4

A reflector according to this example is a reflecting mirror, and is different from the reflector according to Example 1 in that a film structure of a dielectric multilayer is different from the film structure of the dielectric multilayer 15. In the other respects, the reflector according to this embodiment is similar to the reflector according to Example 1.

A dielectric multilayer according to this example is an optical thin-film laminate formed by alternately laminating a high-refractive-index layer that is an IAD (Ion assisted deposition) film composed of Ta₂O₅, and a low-refractive-index layer that is an IAD film composed of SiO₂, similarly to the dielectric multilayers according to Examples 2 and 3. Refractive indices and absorption coefficients of the IAD film composed of Ta₂O₅ and the IAD film composed of SiO₂ are illustrated in FIG. 6.

When a design wavelength λ0 is 600 nm, a film structure of the dielectric multilayer according to this example in a direction from the side of the board 11 to the air side is as described below. Here, H represents the high-refractive-index layer, L represents the low-refractive-index layer, and a numerical value before H or L represents the thickness of each of the layers, calculated under the assumption that design wavelength λ0×1/4=1. The 0 before the decimal point is omitted.

Dielectric Multilayer .5896H .79954L .67841H .5902L .61871H .7864L .7018H .81667L .6655H .70363L .67981H .81294L .64345H .63555L .65188H .87 178L .83445H .96228L .85763H .78846L .84448H .85255L .82139 H 98332L .91949H 1.01704L .89139H .77987L .71475H .82288L .94151H 1.02223L .92208H 1.09584L 1.05267H 1.08257L 1.03665H 1.16557L 1.0454H 1.06684L 1.05624H 1.16198L 1.07658H 1.0496L 1.01611H 1.0963L 1.06231H 1.07625L 1.06196H 2.05828L

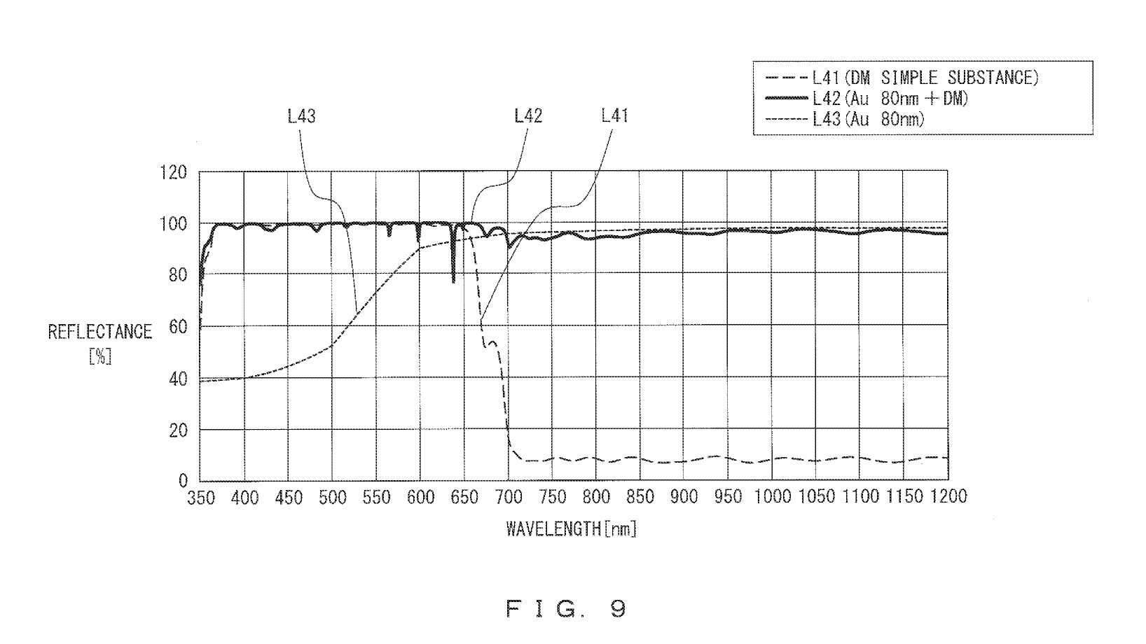

FIG. 9 illustrates spectral reflectances of the reflector, an Au film 12, and the dielectric multilayer according to this example. All of the reflectances are reflectances at an incident angle of 45°. As is clear when comparing a line L41 representing the spectral reflectance of the dielectric multilayer (a DM simple substance) and a line L43 representing the spectral reflectance of the Au film 12, the dielectric multilayer has a reflectance higher than that of the Au film 12 at least in a wavelength region between 400 nm and 600 nm, Further, the dielectric multilayer has a reflectance higher than that of the Au film 12 in a wavelength region between 350 nm and 600 nm.

By using the reflector according to this example, a high reflectance can be achieved in a wide wavelength band from the visible wavelength region to the infrared wavelength region, as represented by a line L42 in FIG. 9, and a high durability against temperature and humidity can also be achieved, similarly to Example 1. Further, a high reflectance can be achieved in the ultraviolet wavelength region. Accordingly, the reflector according to this example can be employed, for example, in a multi-photon excitation microscope that performs three-photon excitation.

### EXAMPLE 5

A reflector according to this example is a reflecting mirror, and is different from the reflector according to Example 1 in that a film structure of a dielectric multilayer is different from the film structure of the dielectric multilayer 15. In the other respects, the reflector according to this embodiment is similar to the reflector according to Example 1.

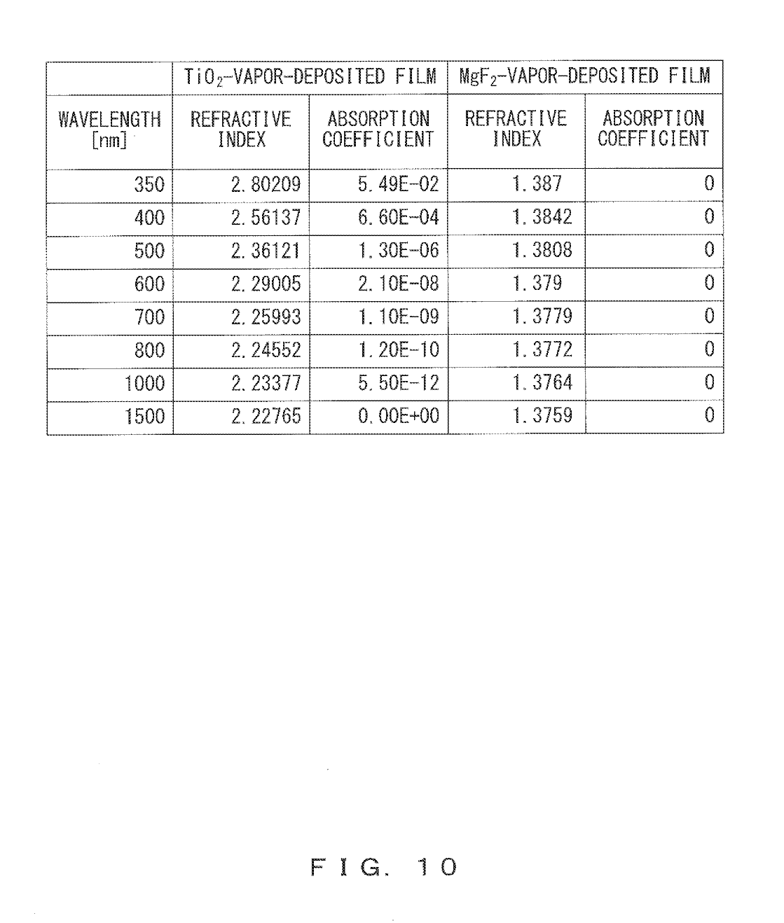

The dielectric multilayer according to this example is an optical thin-film laminate formed by alternately laminating a high-refractive-index layer that is a vapor-deposited film composed of TiO₂, and a low-refractive-index layer that is a vapor-deposited film composed of MgF₂. Refractive indices and absorption coefficients of the vapor-deposited film composed of TiO₂ and the vapor-deposited film composed of MgF₂ are illustrated in FIG. 10. The absorption coefficient of the vapor-deposited film composed of MgF₂ is less than or equal to 10⁻⁶, and therefore the absorption coefficient of the vapor-deposited film composed of MgF₂ is described as 0 in FIG. 10.

When a design wavelength λ0 is 600 nm, a film structure of the dielectric multilayer according to this example in a direction from the side of the board 11 to the air side is as described below. Here, H represents the high-refractive-index layer, L represents the low-refractive-index layer, and a numerical value before H or L represents the thickness of each of the layers that is calculated under the assumption that design wavelength λ0×1/4=1. The 0 before the decimal point is omitted. A numerical value after ( )represents the number of repetitions of a structure described in ( ).

### Dielectric Multilayer (.68H .76L)8 (.86H ,89L)8 (.05H 1.1L)8 1.05H 1.785L

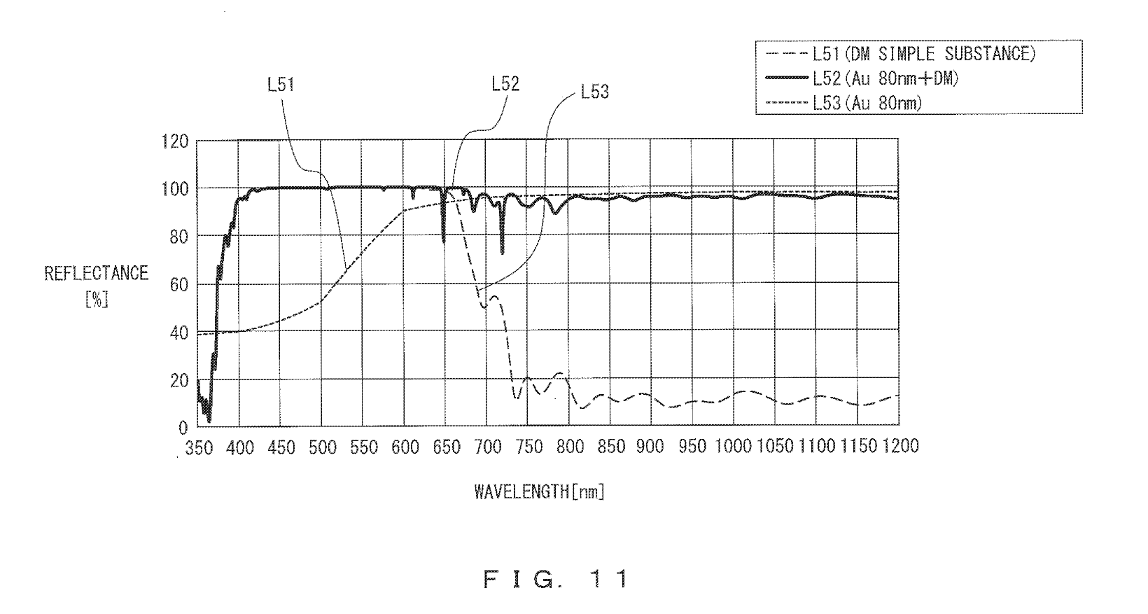

FIG. 11 illustrates spectral reflectances of the reflector, an Au film 12, and the dielectric multilayer according to this example. All of the reflectances are reflectances at an incident angle of 45°. As is clear when comparing a line L51 representing the spectral reflectance of the dielectric multilayer (a DM simple substance) and a line L53 representing the spectral reflectance of the Au film 12, the dielectric multilayer has a reflectance higher than that of the Au film 12 at least in a wavelength region between 400 nm and 600 nm. Further, the dielectric multilayer has a reflectance higher than that of the Au film 12 in a wavelength region between 400 nm and 650 nm.

By using the reflector according to this example, a high reflectance can be achieved in a wide wavelength band from the visible wavelength region to the infrared wavelength region, as represented by a line L52 in FIG. 11, and a high durability against temperature and humidity can also be achieved, similarly to Example 1.

The embodiments described above give specific examples in order that the invention can be easily understood, and the present invention is not limited to the embodiments described above. Various modifications or variations of a reflector and a microscope can be made without departing from the present invention specified in the claims. A single example can be implemented by combining some features in the contexts of respective examples described in the specification.

In FIG. 3, for example, the reflector is arranged in an illumination light path and detection light path in one-photon excitation imaging. However, the reflector may be arranged in a position where visible light and infrared light enter, and maybe arranged, for example, in an illumination light path and detection light path in two-photon excitation imaging. Further, FIG. 3 illustrates a two-photon excitation microscope. However, the reflector may be used in a Raman microscope or an infrared microscope, and may be arranged in at least one of an illumination light path and a detection light path of the Raman microscope or the infrared microscope.

It is preferable that the reflector have an average reflectance of 90% or more in a wavelength region from 400 nm to 1500 nm. It is further preferable that the reflector have an average reflectance of 90% or more in a band from 350 nm to 2000 nm.

What is claimed is:

1. A reflector comprising:
an Au film formed over a board; and
a dielectric multilayer formed over the Au film, the dielectric multilayer having a reflectance higher than that of the Au film in a visible wavelength region.

2. The reflector according to claim 1, wherein
the dielectric multilayer is a dielectric multilayer formed by alternately laminating a high-refractive-index film and a low-refractive-index film having a refractive index lower than a refractive index of the high-refractive-index film so as to have a reflectance higher than that of the Au film at least in a wavelength region from 400 nm to 600 nm.

3. The reflector according to claim 2, wherein
the high-refractive-index film is composed of TiO₂ or Ta₂O₅, and
the low-refractive-index film is composed of SiO₂ or MgF₂.

4. The reflector according to claim 1, wherein
the Au film has a thickness of 80 nm or more.

5. The reflector according to claim 2, wherein
the Au film has a thickness of 80 nm or more.

6. The reflector according to claim 3, wherein
the Au film has a thickness of 80 nm or more.

7. A microscope comprising:
the reflector according to claim 1.

8. The microscope according to claim 7, wherein
the microscope is an infrared microscope, a Raman microscope, or a two-photon excitation microscope.
